(19) United States
(12) Patent Application Publication
(10) Pub. No.: US 2015/0261390 A1
(43) Pub. Date: Sep. 17, 2015

(54) Contextual Disk Menu

(71) Applicant: Boyd Stephen Edmondson, Bothell, WA (US)

(72) Inventor: Boyd Stephen Edmondson, Bothell, WA (US)

(21) Appl. No.: 14/209,737

(22) Filed: Mar. 13, 2014

(51) Int. Cl. G06F 3/0482

(52) U.S. Cl. CPC G06F 3/0482

(57) ABSTRACT

Conventional computer user interface contextual menus are made more efficient by spacing menu items equidistantly from the contextual menu trigger point.

### CROSS REFERENCE TO RELATED APPLICATIONS

Not Applicable

### STATEMENT REGARDING FEDERALLY SPONSORED RESEARCH OR DEVELOPMENT

Not Applicable

### NAMES OF PARTIES TO A JOINT RESEARCH AGREEMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention is in the technical field of computer software. More particularly, the present invention is in the technical field of graphical user interfaces. Even more particularly, the present invention is in the technical field of contextual menus.

Conventional contextual menus display their entries in a linear fashion. Subsequent menu item entries are farther from the contextual trigger point. The cost of user pointing device movement is different and increases for each subsequent menu item.

### BRIEF SUMMARY OF THE INVENTION

The present invention allows for contextual menu items to be equal distance from the contextual menu trigger point.

### BRIEF DESCRIPTION OF THE SEVERAL VIEWS OF THE DRAWING

FIG. 1 is a view of a conventional contextual menu

FIG. 2 is view of the present invention

FIG. 3 is a view of the present invention with a subsequent ring

### DETAILED DESCRIPTION OF THE INVENTION

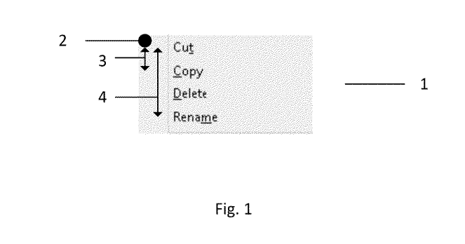

A problematic conventional contextual menu 1 is shown in FIG. 1. The contextual menu trigger point 2 is where user pointing device begins its origin of travel to reach destination target menu item 3. The distance traveled to 4 is greater than the distance to 3. This is inefficient use of user pointing device and gives undo preference to menu items listed closer to the contextual menu trigger point 2.

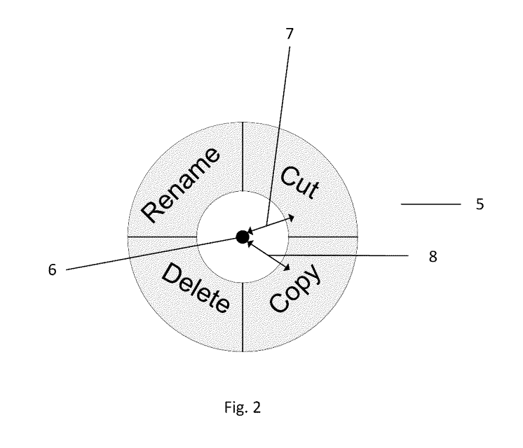

FIG. 2 shows a view of the present invention 5. Its contextual menu trigger point 6 is equidistant from all menu items. The distance traveled by the user pointing device for menu item 7 is the same as the distance that must be traveled for menu item 8. No distance preference is given to any particular menu items.

This present invention improves the efficiency by shortening the distance that user pointing device must be moved, and therefore decreases the time for the user to select menu items in general.

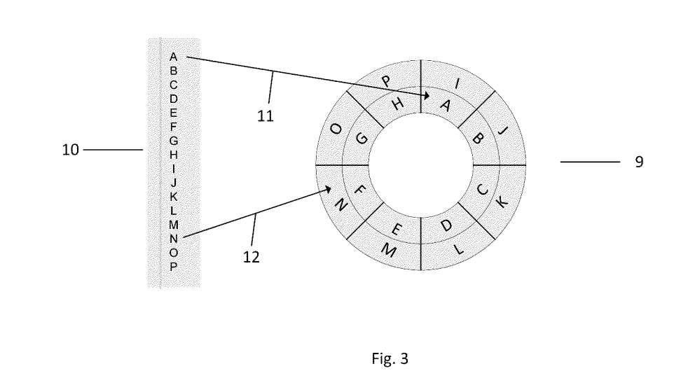

FIG. 3 shows a view of this present invention where subsequent outer rings 9 are utilized when a single ring cannot contain all menu items in a legible manner. 11 shows the positional translation of an inner ring menu item from a conventional contextual menu 10 and 12 shows the positional translation of an outer ring menu item from a conventional contextual menu 10.

1. I claim that conventional contextual menus are inefficient wherein the improvement comprises the utilization of equidistant menu items to improve efficiency.
